(19) United States
(12) Patent Application Publication
(10) Pub. No.: US 2015/0128767 A1
(43) Pub. Date: May 14, 2015

(54) PENETRATION-TYPE RATCHET WRENCH

(71) Applicant: Chia-Yu CHEN, Taichung (TW)

(72) Inventor: Chia-Yu CHEN, Taichung (TW)

(21) Appl. No.: 14/080,354

(22) Filed: Nov. 14, 2013

(51) Int. Cl. B25B 13/46

(52) U.S. Cl. CPC B25B 13/461
USPC 81/60

(57) ABSTRACT

A penetration-type ratchet wrench includes a wrench body having a ratchet wheel assembled in the interior. The ratchet wheel is formed with a polygonal sleeve joint hole for a sleeve to be fitted therein and has one end protrusively formed with a first neck. When the first neck has its outer circumferential side cut into a ring groove through lathe processing, the corners in the sleeve joint hole will respectively and transversely formed into a curved elastic plate. The elastic plates of the ratchet wheel can elastically stop the joint portion of the sleeve for restrictedly positioning the sleeve in the sleeve joint hole and also can elastically and tightly push against the outer circumferential wall of the sleeve for firmly clamping and securing the sleeve in the interior of the wrench body.

### BACKGROUND OF THE INVENTION

1. Field of the Invention

This invention relates to a penetration type ratchet wrench, particularly to one easy to be processed and manufactured and low in production cost.

2. Description of the Prior Art

A conventional penetration type ratchet wrench, as shown in FIGS. 1 and 2, includes a wrench body 1 formed with a head 2 having a ratchet wheel 3 pivotally assembled therein. The ratchet wheel 3 is formed with a first end 4 and a second end 5, with the first end 4 protruding out of the wrench body 1 to be combined with a driving ring 6, and the ratchet wheel 3 is bored with a polygonal sleeve joint hole 7 for securing therein a sleeve 40 that is formed with a joint head 41. The sleeve joint hole 7 of the ratchet wheel 3 has its inner circumferential wall annularly provided with an engage groove 8 at a location corresponding to the first end 4 for receiving a C-shaped retainer 9 therein, and the second end 5 of the ratchet wheel 3 has its outer circumferential wall disposed with a resisting portion. Thus, when the sleeve 40 is combined with the sleeve joint hole 7 of the ratchet wheel 3, the C-shaped retainer 9 will elastically push against the joint head 41 of the sleeve 40 for restrictedly positioning the sleeve 40 to prevent the sleeve 40 from shifting in the sleeve joint hole 7 in a process of operation.

However, the ratchet wheel 3 of the conventional penetration type ratchet wrench needs to be processed for making up the engage groove 8 in the interior of the sleeve joint hole 7 and the C-shaped retainer 9 must be received in the engage groove 8 to enable the sleeve 40 to be restrictedly positioned in the sleeve joint hole 7. When the C-shaped retainer 9 is removed, the conventional penetration type ratchet wrench will be unable to restrictedly position the sleeve 40 and as a result, the sleeve 40 is apt to shift in the sleeve joint hole 7 and it is impossible for a user to smoothly apply force and rotate the sleeve 40 in an operation process. In addition, it will increase manufacturing cost to have the conventional penetration type ratchet wrench provided with the C-shaped retainer 9 and further, the C-shaped retainer 9 is likely to disengage from the engage groove 8 or become dead locked. Therefore, the conventional penetration type ratchet wrench has to be ameliorated and it is necessary to devise a penetration type ratchet wrench that is easy to be processed and manufactured, low in cost and quick in assembly and that is needless to be provided with the C-shaped retainer 9 and still able to stably and elastically resist and tightly push against the sleeve 40.

### SUMMARY OF THE INVENTION

The invention is devised to offer a penetration-type ratchet wrench, which is easy to be processed and manufactured, low in production cost and able to be stably combined with a sleeve. The penetration-type ratchet wrench in the present invention includes a wrench body having one end formed into a head, which has one side provided with an accommodating groove and another side bored with a first insert hole communicating with the accommodating groove. A ratchet wheel is received in the accommodating groove and has two axial ends respectively and protrusively formed with a first neck and a second neck, and the first neck is to be inserted in the first insert hole to have the ratchet wheel fitted and restrictedly positioned in the accommodating groove of the wrench body. Further, he ratchet wheel is axially provided with a polygonal sleeve joint hole along the first insert hole of the head of the wrench body. Furthermore, the ratchet wheel has the outer circumferential side of the first neck annularly cut with a ring groove with a predetermined depth and has the corners in the sleeve joint hole respectively and transversely formed into a curved elastic plate whose arcuate portion slightly protrudes out of the inner circumferential wall of the sleeve joint hole to form an elastic stop. A back cover to be covered on the outer side of the accommodating groove of the wrench body is bored with a second insert hole by which the back cover can be fitted and restrictedly positioned around the second neck of the ratchet wheel.

When a sleeve is inserted and fixed in the sleeve joint hole of the ratchet wheel of the penetration type ratchet wrench of this invention, the elastic plates will function to elastically stop the circumferential edge of the joint portion of the sleeve to secure the sleeve in the sleeve joint hole and prevent the sleeve from shifting linearly during operation of the wrench body. Additionally, in case the joint portion of the sleeve protrudes out of the ratchet wheel, the elastic plates are still able to tightly push against the outer circumferential wall of the sleeve. By so designing, the penetration-type ratchet wrench of this invention is provided with the elastic plates in the sleeve joint hole to take the place of the C-shaped retainer for elastically stopping and tightly pushing against the sleeve, able to achieve effects of facilitating manufacturing and lowering production cost, and also effectively ameliorate the defects that the C-shaped retainer of the conventional penetration type ratchet wrench is likely to disengage from the engage groove after using for a long time.

### BRIEF DESCRIPTION OF DRAWINGS

This invention will be better understood by referring to the accompanying drawings, wherein:

FIG. 1 is an exploded perspective view of a conventional penetration type ratchet wrench;

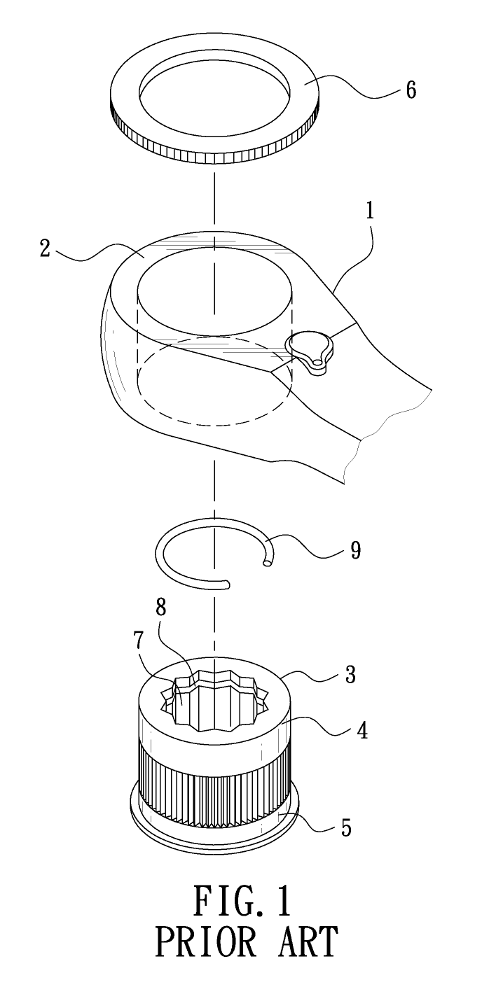

FIG. 2 is a partial cross-sectional view of the conventional penetration type ratchet wrench combined with a sleeve;

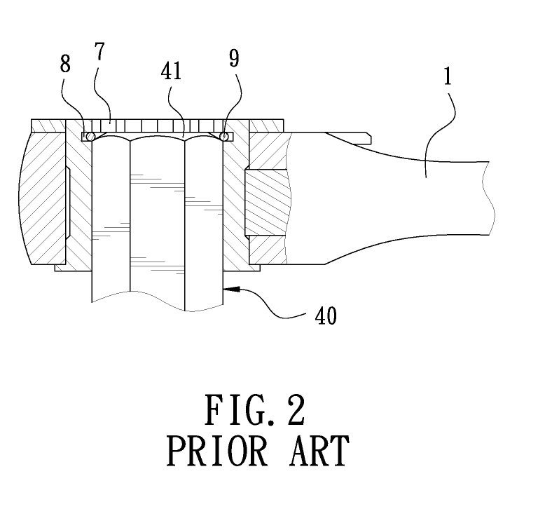

FIG. 3 is an exploded perspective view of a first preferred embodiment of a penetration type ratchet wrench in the present invention;

FIG. 4 is an upper view of the first preferred embodiment of a ratchet wrench in the present invention;

FIG. 5 is a partial cross-sectional view of the first preferred embodiment of the penetration type ratchet wrench in the present invention;

FIG. 6 is a schematic view of the first preferred embodiment of the penetration type ratchet wrench in a using condition in the present invention;

FIG. 7 is a schematic view of a second preferred embodiment of a penetration type ratchet wrench in a using condition in the present invention;

FIG. 8 is an exploded perspective view of a third preferred embodiment of a ratchet wheel and a C-shaped retainer in the present invention; and

FIG. 9 is an upper view of the third preferred embodiment of the ratchet wheel in the present invention.

### DETAILED DESCRIPTION OF THE PREFERRED EMBODIMENT

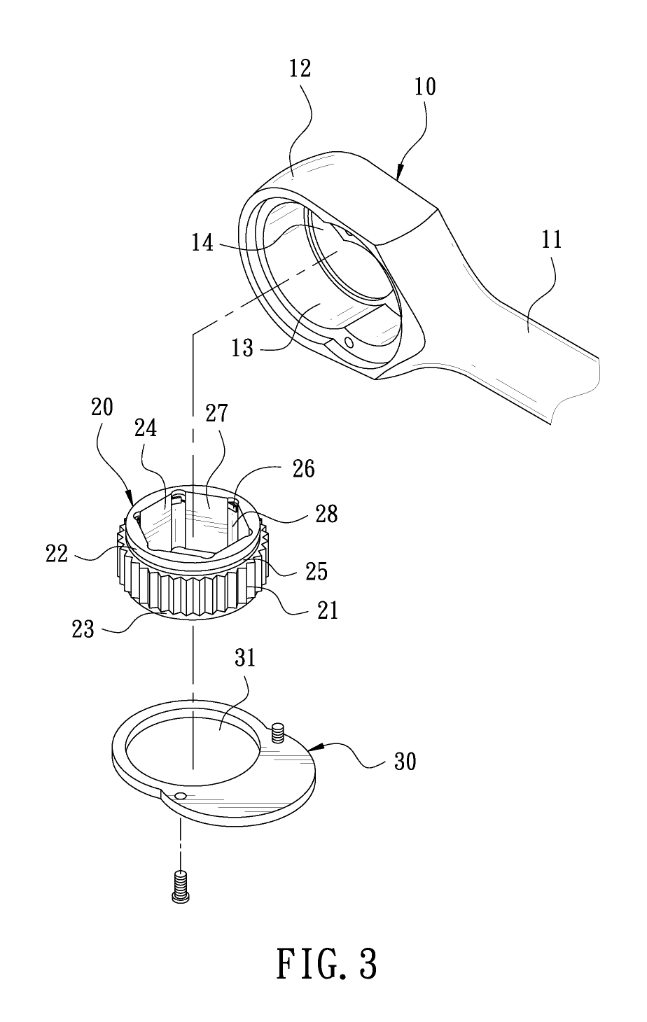

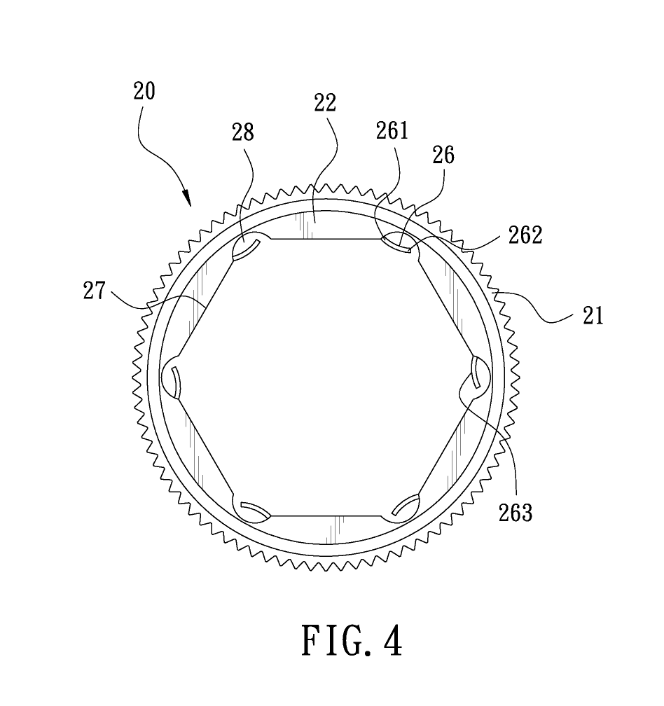

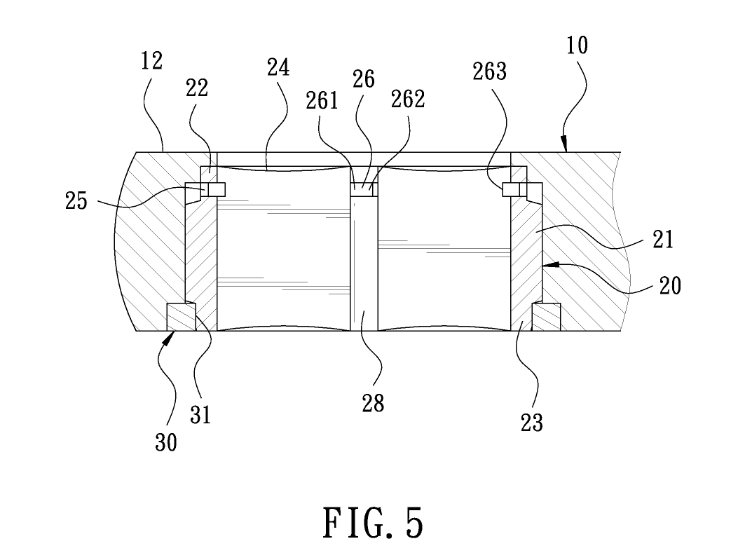

A first preferred embodiment of a penetration type ratchet wrench in the present invention, as shown in FIGS. 3, 4 and 5, includes a wrench body 10, a ratchet wheel 20 and a back cover 30 as main components combined together.

The wrench body 10 is provided with a handle 11 having one end formed into a head 12, which has one side disposed with an accommodating groove 13 and another side bored with a first insert hole 14 communicating with the accommodating groove 13.

The ratchet wheel 20 of column-shape in external appearance and having its outer circumferential wall annularly provided with ratchet 21 is to be positioned in the accommodating groove 13 of the wrench body 10. The ratchet wheel 20 has two axial ends respectively and protrusively provided with a first neck 22 and a second neck 23, with the first neck 22 inserted in the first insert hole 14 of the wrench body 10 to let the ratchet wheel 20 fitted and restrictedly positioned in the accommodating groove 13. Further, the ratchet wheel 20 is axially bored with a polygonal sleeve joint hole 24 having its inner circumferential wall formed with a plurality of joint surfaces 27, and the corner of every adjacent two joint surfaces 27 is axially provided with a recess 28. Furthermore, the outer circumferential side of the first neck 22 of the ratchet wheel 20 is cut with a ring groove 25 through lathe processing, and when the ring groove 25 is processed and shaped to a predetermined depth, the bottom side of the ring groove 25 will be transversely formed into elastic plates 26, which are respectively bent inward at each corner of adjacent two joint surfaces 27, and the curved portions of the elastic plates 26 somewhat protrude out of the inner circumferential wall of the sleeve joint hole 24 to form elastic stops 263. Each elastic plate 26 has a fixed end 261 and a free end 262, and the fixed end 261 is connected with the ring groove 25 of the ratchet wheel 20, while the free ends 262 of the elastic plates 26 extend in the same direction because of the rotating direction of lathe processing.

The back cover 30 to be covered on the outer side of the accommodating groove 13 of the wrench body 10 is bored with a second insert hole 31 to enable the back cover 30 to be fitted and restrictedly positioned around the second neck 23 of the ratchet wheel 20.

To assemble the penetration-type ratchet wrench of this invention, firstly, have the first neck 22 of the ratchet wheel 20 corresponding to and inserted in the first insert hole 14 of the wrench body 10, letting the ratchet wheel 20 fitted and positioned in the accommodating groove 13. Next, have the second insert hole 31 of the back cover 30 fitted and restrictedly positioned around the second neck 33 of the ratchet wheel 20, letting the back cover 30 closely fixed at the outer side of the head 12 of the wrench body 10, thus finishing assembly of the penetration-type ratchet wrench.

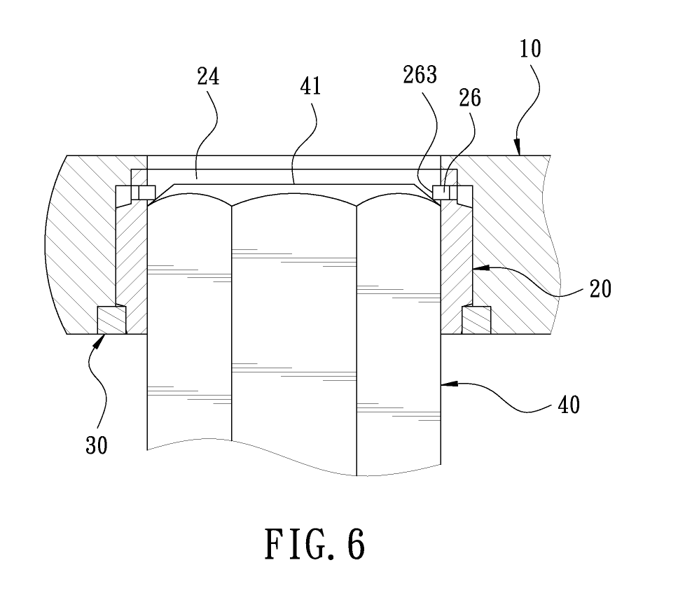

Referring to FIG. 6, to have a sleeve 40 jointed with the wrench body 10 for use, simply have the sleeve 40 directly inserted in the sleeve joint hole 24 of the ratchet wheel 20. At this time, since the ratchet wheel 20 is formed with the elastic plates 26 and the elastic stops 263 of the elastic plates 26 a little protrude out the inner circumferential wall of the sleeve joint hole 24, the elastic stops 263 of the elastic plates 26 will stop the joint portion 41 of the sleeve 40 to make the sleeve 40 fixedly positioned in the sleeve joint hole 24 of the ratchet wheel 20, thus, preventing the sleeve joint hole 24 of the ratchet wheel 20 from shifting along the outer circumferential wall of the sleeve 40. If the joint portion 41 of the sleeve 40 protrudes out of the ratchet wheel 20 and is positioned higher than the elastic stops 263 of the elastic plates 26, the elastic plates 26 still can elastically and tightly push against the outer circumferential wall of the sleeve 40 to have the sleeve 40 firmly clamped in the sleeve joint hole 24 of the ratchet wheel 20. Moreover, the elastic plates 26 are made up through lathe processing so they are comparatively easy to be processed and manufactured, and hence the penetration-type ratchet wrench of this invention can be assembled with quickness.

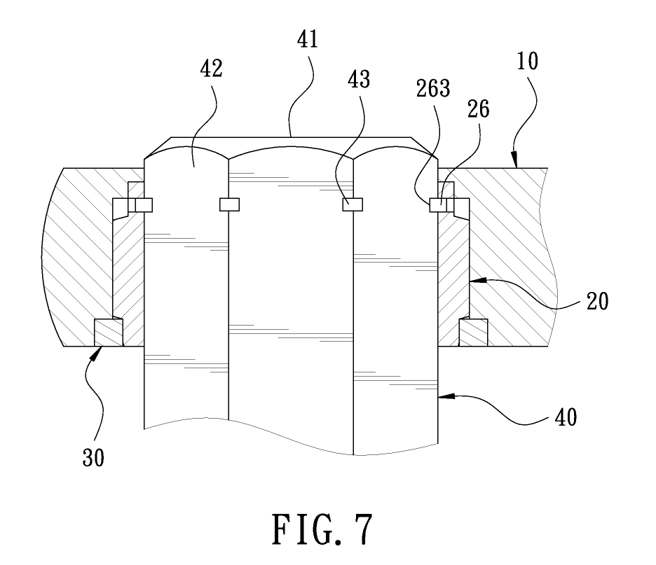

A second preferred embodiment of a penetration type ratchet wrench in the present invention, as shown in FIG. 7, is to have the outer circumferential wall of the sleeve formed with a plurality of braking surfaces 42 and the corner between adjacent two braking surfaces 42 is bored with an engage groove 43 at a same level, and the ratchet wheel 20 is formed with a plurality of elastic plates 26. When the sleeve joint hole 24 of the ratchet wheel 20 is combined with the sleeve 40, the elastic stops 263 of the elastic plates 26 will be respectively engaged in the engage grooves 43 of the sleeve 40 to have the sleeve 40 secured at the locations of the elastic stops 263. Thus, by having the elastic stops 263 of the elastic plates 26 engaged in the engage grooves 43 of the sleeve 40, the sleeve 40 can be stably secured in the interior of the ratchet wheel 20 of the wrench body 10 and prevented from falling off the wrench body 10, effectively elevating convenience in using the tool.

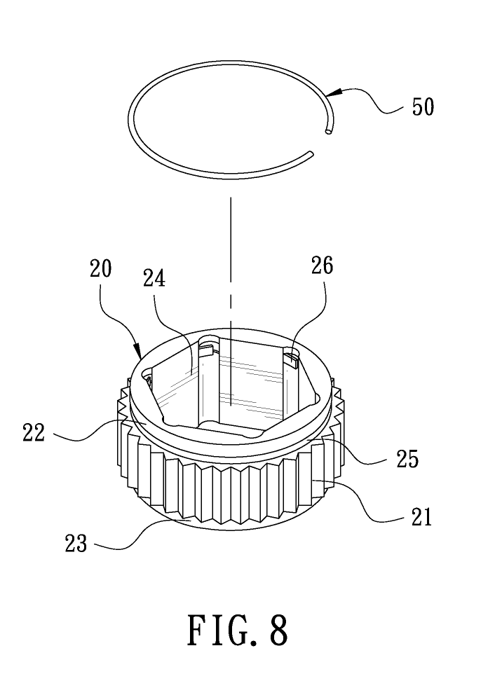

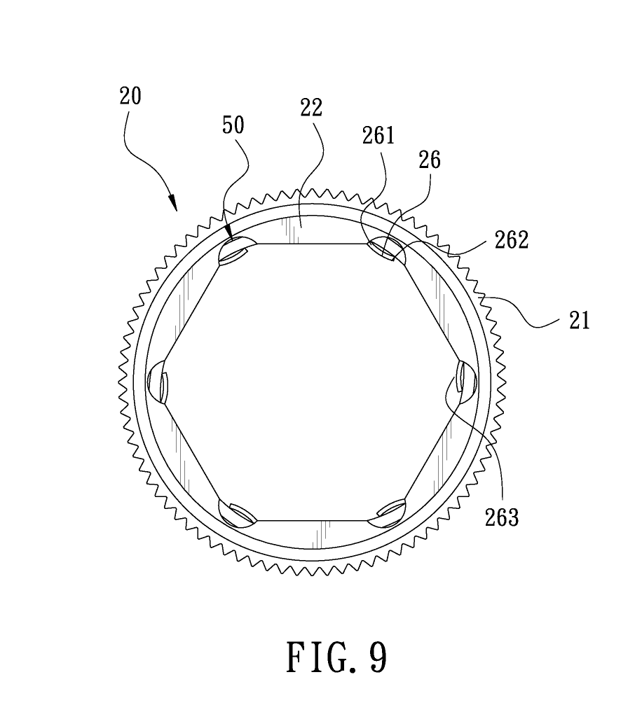

A third preferred embodiment of a penetration type ratchet wrench in the present invention, as shown in FIGS. 8 and 9, is to have a C-shaped retainer 50 received in the ring groove 25 of the ratchet wheel 20. When being received in the ring groove 25, the C-shaped retainer 50 will elastically hold and push the elastic plates 26 at the inner wall of the sleeve joint hole 24 for reinforcing the elastic plates 26 when the elastic plates 26 are fitted around the sleeve 40. In addition, the C-shaped retainer 50 can avoid the elastic plates 26 being deformed or broken after the wrench body 10 has been used for locking or loosening the sleeve 40 for a long period of time.

While the preferred embodiments of the invention have been described above, it will be recognized and understood that various modifications may be made therein and the appended claims are intended to cover all such modifications that may fall within the spirit and scope of the invention.

What is claimed is:

1. A penetration-type ratchet wrench comprising a wrench body, said wrench body having a front end formed into a head, said head provided with an accommodating groove in an interior, said head having another side bored with a first insert hole communicating with said accommodating groove, a ratchet wheel received in said accommodating groove, said ratchet wheel having interior axially formed into a polygonal sleeve joint hole, said sleeve joint hole having an inner circumferential wall formed with a plurality of joint surfaces for fitting around a sleeve and driving said sleeve to rotate; and characterized by
said ratchet wheel having an upper edge axially provided with a first neck, said first neck having an outer circumferential wall annularly disposed with a ring groove, said ring groove of said ratchet wheel having a bottom side transversely formed into curved elastic plates respectively at a corner of adjacent two said joint surfaces of said sleeve joint hole, said curved elastic plates protruding out of the inner circumferential wall of said sleeve joint hole, said elastic plates respectively formed with a fixed end and a free end, said fixed end connected with a bottom side of said ring groove;
when having a sleeve combined with said sleeve joint hole, said elastic plates elastically stopping a joint portion of said sleeve to prevent said sleeve from shifting in said sleeve joint hole, said elastic plates able to elastically and tightly push against the outer circumferential wall of said sleeve to secure said sleeve in said wrench body and avoid said sleeve from falling off said sleeve joint hole in an operation process.

2. The penetration-type ratchet wrench as claimed in claim 1, wherein said elastic plates are respectively bent into a curved shape toward the inner side of said sleeve joint hole in the same direction, and the curved portion of said elastic plate is formed into an elastic stop.

3. The penetration type ratchet wrench as claimed in claim 1, wherein a corner of adjacent two said joint surfaces of said sleeve joint hole is axially provided with a recessed groove.

4. The penetration type ratchet wrench as claimed in claim 1, wherein a C-shaped retainer is received in said ring groove for increasing strength of said elastic plates.
